(19) United States
(12) Patent Application Publication
(10) Pub. No.: US 2025/0012949 A1
(43) Pub. Date: Jan. 9, 2025

(54) MULTIFUNCTIONAL RESIN LENS FOR AR GLASSES CAPABLE OF CORRECTING VISION AND FABRICATION METHOD THEREOF

(71) Applicant: Jiangsu Conant Optical Co.,Ltd, Nantong (CN)

(72) Inventors: Chuanbao Wang, Nantong (CN); Linxing Chu, Nantong (CN)

(21) Appl. No.: 18/495,670

(22) Filed: Oct. 26, 2023

(30) Foreign Application Priority Data
Jul. 6, 2023 (CN) 202310821654.X

(51) Int. Cl. G02B 1/14; B29D 11/00

(52) U.S. Cl. CPC G02B 1/14; B29D 11/00009; B29D 11/0073; B29D 11/00865

(57) ABSTRACT

Disclosed is a multifunctional resin lens for AR glasses capable of correcting vision, which includes a lens base, wherein multifunctional hard layers are disposed on both upper and lower end faces of the lens base; a multifunctional film layer is disposed on the other side of each of the multifunctional hard layers; the lens consisting of the lens base, the multifunctional hard layers, and the multifunctional film layers is a structure having a flat upper end face and a curved lower end face; and an optical waveguide sheet is disposed on the upper multifunctional film layer of the lens base. The lens of the present disclosure may be integrated with multiple functions to facilitate use thereof, has high optical performance, and can achieve a good visual field quality and an AR display effect while achieving lightweight and thinness.

### CROSS-REFERENCE TO RELATED APPLICATIONS

This application claims priority of Chinese Patent Application No. 202310821654. X, filed on Jul. 6, 2023, the entire contents of which are incorporated herein by reference.

### TECHNICAL FIELD

The present disclosure relates to the technical field of AR glasses, and particularly to a multifunctional resin lens for AR glasses capable of correcting vision and a fabrication method thereof.

### BACKGROUND

With the continuous development of intelligent computer technologies, intelligent products emerge constantly. Following smartphones and tablets, virtual reality (VR) and augmented reality (AR) have the potential to become the next major universal computing platforms. With the continuous decline in smartphone sales volume, VR and AR technologies become another important direction for consumer electronics. The VR technology refers to a technology that comprehensively utilizes computer graphic apparatuses and various reality and control interface devices to provide a sense of immersion in a computer-generated interactive three-dimensional environment. The AR refers to the application of virtual information to the real world using a computer technology, where a real environment and a virtual object are superimposed onto the same frame or space in real time and are present simultaneously.

Currently, more companies choose to enter the VR field, and research reports from major research companies and investment banks on the VR field also emerge in endlessly. In contrast, although the media has begun to report on AR technologies extensively in the past year, most of them are still under development. The AR technology can achieve interaction between reality and virtuality, and has broader application prospects than VR. With the widespread application of the AR technology in the field of gaming and entertainment, the AR technology is also well applied in the field of education and engineering. For example, in the field of engineering, people can use the AR technology to truly combine a three-dimensional unit model with a two-dimensional image, so as to present a structure of the model more realistically and stereoscopically. In the field of education, people can also combine an original two-dimensional book with a three-dimensional model, a three-dimensional animation, an image, and a sound to construct a virtual study scene vividly, so that children do not feel bored in study and may accept knowledge faster.

### Defects in the Existing Technology:

The existing AR glasses have a complex structure and work in a mode where lenses are used for imaging on left and right eyes separately, easily causing dizziness. Meanwhile, a display has poor resolution, resulting in the presence of noises after zoom-in, and thereby affecting an experience effect. In addition, physical health of users addicted to AR games for a long time may be affected, and the existing AR glasses cannot enable the users to learn their physical conditions timely. Furthermore, the AR glasses on the market all have no refractive power, thus requiring people to wear AR zero-power glasses after wearing normal vision correction glasses, which leads to complicated use and complex structure of the AR glasses. Currently, there are no AR glasses capable of correcting vision.

### SUMMARY

The present disclosure aims to provide a multifunctional resin lens for AR glasses capable of correcting vision and a fabrication method thereof, so as to solve the problems as proposed in the above Background.

A multifunctional resin lens for AR glasses capable of correcting vision includes a lens base, wherein multifunctional hard layers are disposed on both upper and lower end faces of the lens base; a multifunctional film layer is disposed on the other side of each of the multifunctional hard layers; the lens consisting of the lens base, the multifunctional hard layers, and the multifunctional film layers is a structure having a flat upper end face and a curved lower end face; and an optical waveguide sheet is disposed on the upper multifunctional film layer of the lens base.

As a further improvement of the present disclosure, the lens base is a multifunctional resin base that includes any one or more of an anti-blue light base, a color change base, a dyeable base, and an anti-infrared light base, and a material of the lens base includes any one of acrylate, polyurethane, polycarbonate, and allyl carbonate.

As a further improvement of the present disclosure, the multifunctional hard layer includes one or more of an anti-scratch hardened layer, an anti-impact hardened layer, and a dyeable hardened layer.

As a further improvement of the present disclosure, the multifunctional film layer includes any one or more of a light anti-reflection film, an anti-electromagnetic radiation film, a waterproof film, and an anti-fog film.

As a further improvement of the present disclosure, the optical waveguide sheet is adhered using an OCA, and an adhesive thickness of the optical waveguide sheet is less than 200 microns.

The present disclosure further provides a fabrication method of a multifunctional resin lens for AR glasses capable of correcting vision. The fabrication method includes the following steps: S1. raw material preparation and molding by casting; S2. demolding pretreatment; S3. multifunctional hard layer dip-coating; S4. lens pre-drying, picking-out, and curing; S5. multifunctional film layer plating; S6. picking-out, packaging, and axis line marking; and S7. optical waveguide sheet adhesion, wherein:
S1. raw material preparation and molding by casting comprises:
a1. preparing and uniformly stirring a multifunctional base raw material; and
a2. injecting the multifunctional base material into two glass molds, one being a flat glass mold and the other being a curved mold, which are sealed using a tape, with a distance between working faces of the two molds being 0.6-3 mm;
S3. multifunctional hard layer dip-coating comprises: dip-coating lenses undergoing S2. demolding pretreatment with multifunctional hard layers for hardening, with a thickness of the multifunctional hard layer being 1.5-5 microns;
S5. multifunctional film layer plating comprises: performing vacuum plating on lenses undergoing S4. lens pre-drying, picking-out, and curing, to plate front and rear surfaces of the lenses with multifunctional film layers respectively.

As a further improvement of the present disclosure, S2. demolding pretreatment in the method includes the following steps:
b1. placing the molds in which the multifunctional base material is injected into a curing oven for curing, at curing temperature of 20-125° C. and for a curing time of 4-48 hours;
b2. taking out cured lenses, tearing off the tape, force-opening the glass molds, and separating the lenses from the glass molds;
b3. edge-grinding the separated lenses into lenses with a specified diameter;
b4. performing ultrasonic cleaning on the ground lenses;
b5. performing secondary curing and annealing treatment on the cleaned lenses, at a temperature of 65-130° C. and for a time of 8-50 hours;
b6. inspecting the lenses undergoing the annealing treatment and picking out qualified lenses;
b7. placing the qualified lenses into a wiping machine for wiping and cleaning;
b8. placing the wiped lenses into an alkaline bath for surface treatment, at an alkaline concentration of 6%-25% and a temperature of 30-60° C.;
b9. placing the lenses undergoing the surface treatment into an ionized water tank for ultrasonic cleaning, at a temperature of 30-60° C.; and
b10. air-drying surfaces of the cleaned lenses.

As a further improvement of the present disclosure, S4. lens pre-drying, picking-out, and curing in the method includes the following steps:
c1. pre-drying the lenses dip-coated with the multifunctional hard layers after S3. multifunctional hard layer dip-coating;
c2. inspecting the pre-dried lenses and picking out qualified lenses; and
c3. curing the hardened qualified lenses.

As a further improvement of the present disclosure, S6. picking-out, packaging, and axis line marking in the method includes the following steps:
d1. inspecting the plated lenses undergoing S5. multifunctional film layer plating, and picking out qualified lenses;
d2. printing and packaging the qualified lenses;
d3. picking out lenses with cylinders, identifying an optical center and an axis line of each of the lenses on a lensometer, and marking a direction of the axis line on a back surface of the lens;
d4. marking the axis line passing through the optical center of the lens on the back surface of the lens using ink; and
d5. processing spherical lenses and line-marked cylindrical lenses into lenses of required shapes and sizes.

As a further improvement of the present disclosure, S7. optical waveguide sheet adhesion in the method includes: adhering an optical waveguide sheet to an optical center position on a flat front surface of the lens using an OCA.

Compared with the existing technology, the present disclosure has the following beneficial effects:

1. The present disclosure includes the lens base, the multifunctional hard layers, the multifunctional film layers, and the optical waveguide sheet. The lens consisting of the multifunctional hard layers and the multifunctional film layers is a structure having a flat upper end face and a curved lower end face. Traditional glasses require multiple pairs of lenses to achieve different functions. The lens of the present disclosure may be integrated with various functions to facilitate use thereof, has high optical performance, and may achieve good visual field quality and an AR display effect while achieving lightweight and thinness. Due to the vision correction function, AR glasses with such lenses are more suitable for people to wear than traditional zero-power AR glasses, and are more favorable to protect eyes and improve AR experience.

2. The method of the present disclosure includes the following steps: S1. raw material preparation and molding by casting; S2. demolding pretreatment; S3. multifunctional hard layer dip-coating; S4. lens pre-drying, picking-out, and curing; S5. multifunctional film layer plating; S6. picking-out, packaging, and axis line marking; and S7. optical waveguide sheet adhesion. The lens is simple in fabrication process, low in cost, and applicable to large-scale production, thus reducing purchase costs for users.

### BRIEF DESCRIPTION OF THE DRAWINGS

FIG. 1 is a schematic structural diagram of a multifunctional resin lens for AR glasses capable of correcting vision of the present disclosure;

FIG. 2 is flow diagram of a fabrication method of a multifunctional resin lens for AR glasses capable of correcting vision of the present disclosure;

FIG. 3 is a characteristic diagram of visible light transmittance of a lens of the present disclosure;

FIG. 4 is a visible light transmittance diagram of a lens of the present disclosure;

FIG. 5 is a diagram of L. a. b values of a visible light transmittance lens of the present disclosure; and

FIG. 6 is an imaging evaluation diagram of a lens of the present disclosure.

In the drawings: 1. lens base; 2. multifunctional hard layer; 3. multifunctional film layer; and 4. optical waveguide sheet.

### DETAILED DESCRIPTION

The technical solution in embodiments of the present disclosure will be clearly and completely described below in conjunction with the drawings in the embodiments of the present disclosure. Apparently, the described embodiments are only part, but not all, of the embodiments of the present disclosure. Based on the embodiments in the present disclosure, all other embodiments obtained by those of ordinary skills in the art without the exercise of inventive effort fall within the scope of protection of the present disclosure.

### Embodiment 1

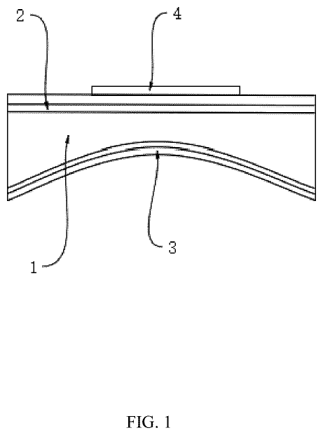

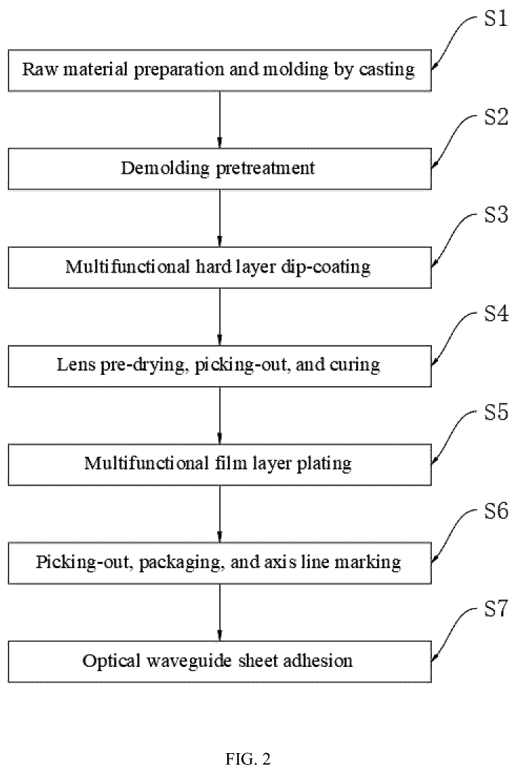

Referring to FIGS. 1-3. the present disclosure provides the following technical solution: a multifunctional resin lens for AR glasses capable of correcting vision includes a lens base 1, wherein multifunctional hard layers 2 are disposed on both upper and lower end faces of the lens base 1; a multifunctional film layer 3 is disposed on the other side of each of the multifunctional hard layers 2; the lens consisting of the lens base 1, the multifunctional hard layers 2, and the multifunctional film layers 3 is a structure having a flat upper end face and a curved lower end face; and an optical waveguide sheet 4 is disposed on the upper multifunctional film layer 3 of the lens base 1.

The lens base 1 is a multifunctional resin base that includes any one or more of an anti-blue light base, a color change base, a dyeable base, and an anti-infrared light base, and a material of the lens base 1 includes any one of acrylate, polyurethane, polycarbonate, and allyl carbonate.

The multifunctional hard layer 2 includes one or more of an anti-scratch hardened layer, an anti-impact hardened layer, and a dyeable hardened layer.

The multifunctional film layer 3 includes any one or more of a light anti-reflection film, an anti-electromagnetic radiation film, a waterproof film, and an anti-fog film.

The optical waveguide sheet 4 is adhered using an OCA, and an adhesive thickness of the optical waveguide sheet 4 is less than 200 microns.

The lens of the present disclosure is fabricated using the following method including:
preparing and uniformly stirring a multifunctional base raw material, and preparing an anti-blue light base from an acrylate base;
injecting the prepared acrylate anti-blue light base material into two glass molds, one being a flat glass mold having a working face of 0-degree curvature, and the other being a curved mold having a working face of 200-degree curvature, wherein the two molds have a distance of 1.0 mm between working face centers thereof, and are sealed using a tape;
placing the molds in which the acrylate anti-blue light base material is injected into a curing oven for curing, with curing temperatures of 20° C. for 1 hour, 80° C. for 1 hour, 90° C. for 36 hours, 95° C. for 4 hours, and 110° C. for 2 hours, and for a curing time of 4-48 hours;
placing the molds in which the acrylate anti-blue light base material is injected into a curing oven for curing, with curing temperatures of 20° C. for 1 hour, 80° C. for 1 hour, 90° C. for 36 hours, 95° C. for 4 hours, and 110° C. for 2 hours, and for a curing time of 4-48 hours;
taking out cured lenses, tearing off the tape, force-opening the glass molds, and separating the lenses from the glass molds;
edge-grinding the lenses into lenses with a diameter of 75 mm;
performing ultrasonic cleaning on the ground lenses with the diameter of 75 mm;
performing secondary curing and annealing treatment on the cleaned lenses, at a temperature of 70° C. and for a time of 48 hours;
inspecting the lenses undergoing the annealing treatment and picking out qualified lenses;
placing the qualified lenses into a wiping machine for wiping and cleaning;
placing the wiped lenses into an alkaline bath for surface treatment, at an alkaline concentration of 20% and a temperature of 55° C.;
air-drying surfaces of the cleaned lenses;
dip-coating the air-dried lenses with anti-scratch, anti-impact hard layers, with a thickness of 2 microns;
pre-drying the lenses dip-coated with the multifunctional hard layers;
inspecting the pre-dried lenses and picking out qualified lenses;
curing the hardened qualified lenses at 120° C. for 2.5 hours;
performing vacuum plating on the cured lenses, to plate front and rear surfaces of the lenses with light anti-reflection film layers respectively;
inspecting the plated lenses and picking out qualified lenses;
printing and packaging the qualified lenses;
picking out lenses with cylinders, identifying an optical center and an axis line of each of the lenses on a lensometer, and marking a direction of the axis line on a back surface of the lens;
marking the axis line passing through the optical center of the lens on the back surface of the lens using ink;
processing spherical lenses and line-marked cylindrical lenses into lenses of required shapes and sizes; and

adhering an optical waveguide sheet to an optical center position on a flat front surface of the lens using an OCA, with an adhesive thickness of 80 microns.

### Comparative Embodiment 1

The method includes: preparing and uniformly stirring a multifunctional base raw material, and preparing an anti-blue light base from an acrylate base; injecting the prepared acrylate anti-blue light base material into two glass molds, one being a curved glass mold having a downward-curving working face of 200-degree curvature, and the other being a curved mold having an upward-curving working face of 400-degree curvature, wherein the two molds have a distance of 1.0 mm between working face centers thereof, and are sealed using a tape;

placing the molds in which the acrylate anti-blue light base material is injected into a curing oven for curing, with curing temperatures of 20° C. for 1 hour, 80° C. for 1 hour, 90° C. for 36 hours, 95° C. for 4 hours, and 110° C. for 2 hours, and for a curing time of 4-48 hours;
taking out cured lenses, tearing off the tape, force-opening the glass molds, and separating the lenses from the glass molds;
edge-grinding the lenses into lenses with a diameter of 75 mm;
performing ultrasonic cleaning on the ground lenses with the diameter of 75 mm;
performing secondary curing and annealing treatment on the cleaned lenses, at a temperature of 70° C. and for a time of 48 hours;
inspecting the lenses undergoing the annealing treatment and picking out qualified lenses;
placing the qualified lenses into a wiping machine for wiping and cleaning;
placing the wiped lenses into an alkaline bath for surface treatment, at an alkaline concentration of 20% and a temperature of 55° C.;
placing the lenses undergoing the surface treatment into an ionized water tank for ultrasonic cleaning, at a temperature of 30-60° C.; and
air-drying surfaces of the cleaned lenses;
dip-coating the air-dried lenses with anti-scratch, anti-impact hard layers, with a thickness of 2 microns;
pre-drying the lenses dip-coated with the multifunctional hard layers;
inspecting the pre-dried lenses and picking out qualified lenses;
curing the hardened qualified lenses at 120° C. for 2.5 hours;
performing vacuum plating on the cured lenses, to plate front and rear surfaces of the lenses with light anti-reflection film layers respectively;
inspecting the plated lenses and picking out qualified lenses;
printing and packaging the qualified lenses;
picking out lenses with cylinders, identifying an optical center and an axis line of each of the lenses on a lensometer, and marking a direction of the axis line on a back surface of the lens;
marking the axis line passing through the optical center of the lens on the back surface of the lens using ink;
processing spherical lenses and line-marked cylindrical lenses into lenses of required shapes and sizes; and
adhering an optical waveguide sheet to an optical center position on a flat front surface of the lens using an OCA, with an adhesive thickness of 4 millimeters.

### Comparative Embodiment 2

The method includes: adding an auxiliary material to an acrylate base for uniform stirring;
injecting the prepared acrylate anti-blue light base material into two glass molds, one being a flat glass mold having a working face of 0-degree curvature, and the other being a curved mold having a working face of 200-degree curvature, wherein the two molds have a distance of 1.0 mm between working face centers thereof, and are sealed using a tape;
placing the molds in which the acrylate anti-blue light base material is injected into a curing oven for curing, with curing temperatures of 20° C. for 1 hour, 80° C. for 1 hour, 90° C. for 36 hours, 95° C. for 4 hours, and 110° C. for 2 hours, and for a curing time of 4-48 hours;
taking out cured lenses, tearing off the tape, force-opening the glass molds, and separating the lenses from the glass molds;
edge-grinding the lenses into lenses with a diameter of 75 mm;
performing ultrasonic cleaning on the ground lenses with the diameter of 75 mm;
performing secondary curing and annealing treatment on the cleaned lenses, at a temperature of 70° C. and for a time of 48 hours;
inspecting the lenses undergoing the annealing treatment and picking out qualified lenses;
printing and packaging the qualified lenses;
picking out lenses with cylinders, identifying an optical center and an axis line of each of the lenses on a lensometer, and marking a direction of the axis line on a back surface of the lens;
marking the axis line passing through the optical center of the lens on the back surface of the lens using ink;
processing spherical lenses and line-marked cylindrical lenses into lenses of required shapes and sizes; and
adhering an optical waveguide sheet to an optical center position on a flat front surface of the lens using an OCA, with an adhesive thickness of 80 microns.

### Comparative Embodiment 3

The method includes: preparing and uniformly stirring a multifunctional base raw material, and preparing an anti-blue light base from an acrylate base;
injecting the prepared acrylate anti-blue light base material into two glass molds, one being a flat glass mold having a working face of 0-degree curvature, and the other being a curved mold having a working face of 200-degree curvature, wherein the two molds have a distance of 3.5 mm between working face centers thereof, and are sealed using a tape;
placing the molds in which the acrylate anti-blue light base material is injected into a curing oven for curing, with curing temperatures of 20° C. for 1 hour, 80° C. for 1 hour, 90° C. for 36 hours, 95° C. for 4 hours, and 110° C. for 2 hours, and for a curing time of 4-48 hours;
taking out cured lenses, tearing off the tape, force-opening the glass molds, and separating the lenses from the glass molds;
edge-grinding the lenses into lenses with a diameter of 75 mm;
performing ultrasonic cleaning on the ground lenses with the diameter of 75 mm;
performing secondary curing and annealing treatment on the cleaned lenses, at a temperature of 70° C. and for a time of 48 hours;
inspecting the lenses undergoing the annealing treatment and picking out qualified lenses;
placing the qualified lenses into a wiping machine for wiping and cleaning;
placing the wiped lenses into an alkaline bath for surface treatment, at an alkaline concentration of 20% and a temperature of 55° C.;
placing the lenses undergoing the surface treatment into an ionized water tank for ultrasonic cleaning, at a temperature of 30-60° C.; and
air-drying surfaces of the cleaned lenses;
dip-coating the air-dried lenses with anti-scratch, anti-impact hard layers, with a thickness of 2 microns;
pre-drying the lenses dip-coated with the multifunctional hard layers;
inspecting the pre-dried lenses and picking out qualified lenses;
curing the hardened qualified lenses at 120° C. for 2.5 hours;
performing vacuum plating on the cured lenses, to plate front and rear surfaces of the lenses with light anti-reflection film layers respectively;
inspecting the plated lenses and picking out qualified lenses;
printing and packaging the qualified lenses;
picking out lenses with cylinders, identifying an optical center and an axis line of each of the lenses on a lensometer, and marking a direction of the axis line on a back surface of the lens;
marking the axis line passing through the optical center of the lens on the back surface of the lens using ink;
processing spherical lenses and line-marked cylindrical lenses into lenses of required shapes and sizes; and
adhering an optical waveguide sheet to an optical center position on a flat front surface of the lens using an OCA, with an adhesive thickness of 80 microns.

### Comparative Embodiment 4

The method includes: preparing and uniformly stirring a multifunctional base raw material, and preparing an anti-blue light base from an acrylate base;
injecting the prepared acrylate anti-blue light base material into two glass molds, one being a flat glass mold having a working face of 0-degree curvature, and the other being a curved mold having a working face of 200-degree curvature, wherein the two molds have a distance of 1.0 mm between working face centers thereof, and are sealed using a tape;
placing the molds in which the acrylate anti-blue light base material is injected into a curing oven for curing, with curing temperatures of 20° C. for 1 hour, 80° C. for 1 hour, 90° C. for 36 hours, 95° C. for 4 hours, and 110° C. for 2 hours, and for a curing time of 4-48 hours;
taking out cured lenses, tearing off the tape, force-opening the glass molds, and separating the lenses from the glass molds;
edge-grinding the lenses into lenses with a diameter of 75 mm;
performing ultrasonic cleaning on the ground lenses with the diameter of 75 mm;
performing secondary curing and annealing treatment on the cleaned lenses, at a temperature of 70° C. and for a time of 48 hours;
inspecting the lenses undergoing the annealing treatment and picking out qualified lenses;
placing the qualified lenses into a wiping machine for wiping and cleaning;
placing the wiped lenses into an alkaline bath for surface treatment, at an alkaline concentration of 20% and a temperature of 55° C.;
placing the lenses undergoing the surface treatment into an ionized water tank for ultrasonic cleaning, at a temperature of 30-60° C.; and
air-drying surfaces of the cleaned lenses;
dip-coating the air-dried lenses with anti-scratch, anti-impact hard layers, with a thickness of 2 microns;
pre-drying the lenses dip-coated with the multifunctional hard layers;
inspecting the pre-dried lenses and picking out qualified lenses;
curing the hardened qualified lenses at 120° C. for 2.5 hours;
inspecting the cured lenses and picking out qualified lenses;
printing and packaging the qualified lenses;
picking out lenses with cylinders, identifying an optical center and an axis line of each of the lenses on a lensometer, and marking a direction of the axis line on a back surface of the lens;
marking the axis line passing through the optical center of the lens on the back surface of the lens using ink;
processing spherical lenses and line-marked cylindrical lenses into lenses of required shapes and sizes; and
adhering an optical waveguide sheet to an optical center position on a flat front surface of the lens using an OCA, with an adhesive thickness of 80 microns.

### Comparative Embodiment 5

The method includes: preparing and uniformly stirring a multifunctional base raw material, and preparing an anti-blue light base from an acrylate base;

injecting the prepared acrylate anti-blue light base material into two glass molds, one being a flat glass mold having a working face of 0-degree curvature, and the other being a curved mold having a working face of 200-degree curvature, wherein the two molds have a distance of 1.0 mm between working face centers thereof, and are sealed using a tape;
placing the molds in which the acrylate anti-blue light base material is injected into a curing oven for curing, with curing temperatures of 20° C. for 1 hour, 80° C. for 1 hour, 90° C. for 36 hours, 95° C. for 4 hours, and 110° C. for 2 hours, and for a curing time of 4-48 hours;
taking out cured lenses, tearing off the tape, force-opening the glass molds, and separating the lenses from the glass molds;
edge-grinding the lenses into lenses with a diameter of 75 mm;
performing ultrasonic cleaning on the ground lenses with the diameter of 75 mm;
performing secondary curing and annealing treatment on the cleaned lenses, at a temperature of 70° C. and for a time of 48 hours;
inspecting the lenses undergoing the annealing treatment and picking out qualified lenses;
performing vacuum plating on the qualified lenses, to plate front and rear surfaces of the lenses with light anti-reflection film layers respectively;
inspecting the plated lenses and picking out qualified lenses;
printing and packaging the qualified lenses;
picking out lenses with cylinders, identifying an optical center and an axis line of each of the lenses on a lensometer, and marking a direction of the axis line on a back surface of the lens;
marking the axis line passing through the optical center of the lens on the back surface of the lens using ink;
processing spherical lenses and line-marked cylindrical lenses into lenses of required shapes and sizes; and
adhering an optical waveguide sheet to an optical center position on a flat front surface of the lens using an OCA, with an adhesive thickness of 80 microns.

A visible light transmittance test instrument TM-8S and a wear resistance test instrument YT-520 Lens Surface Hardness Test are used to test the lenses fabricated in Embodiment 1, Comparative Embodiment 1, Comparative Embodiment 2, Comparative Embodiment 3, Comparative Embodiment 4, and Comparative Embodiment 5 against a film layer test standard QB T2506-2017. Test results are shown in Table 1:

TABLE I

| | OCA adhesion | | Wear | Visible light |
|---|---|---|---|---|
| | thickness | | resistance | transmittance |
| Embodiment 1 | 80 | microns | No scratch | 96.9% |
| Comparative | 4 | millimeters | No scratch | 95.5% |
| Embodiment 1 | | | | |
| Comparative | 80 | microns | Obvious | 88% |
| Embodiment 2 | | | scratch | |
| Comparative | 80 | microns | No scratch | 87% |
| Embodiment 3 | | | | |
| Comparative | 80 | microns | No scratch | 89% |
| Embodiment 4 | | | | |
| Comparative | 80 | microns | Having | 95% |
| Embodiment 5 | | | scratches | |

The characteristics of the lenses in the Embodiment and the Comparative Embodiments are verified through experiments, and results are shown in Table II:

TABLE II

| | | | | | Wear |
|---|---|---|---|---|---|
| | | | | Water | resistance |
| | | Anti-blue | Anti- | drop | against a |
| | Light | light | electromagnetic | contact | 750 g |
| | transmittance | function | wave test | angle | weight |
| Embodiment | 94.68% | Yes | Yes | 108° | No damage |
| Comparative | 90.66% | No | No | 44° | Damage |
| Embodiments | | | | | |

Notes: test instrument: TM-8S, optical transmittance tester; electromagnetic radiation tester; water drop contact angle tester; and wear resistance tester.

As can be seen from the tables above, for use of molds in Embodiment 1 and Comparative Embodiment 1, a combination of one flat mold and one concave mold is more favorable to OCA adhesion and makes the lens more aesthetic. It can be seen from Embodiment 1 and Comparative Embodiment 2 that multi-functional lenses are better than single-functional lenses. It can be seen from Embodiment 1 and Comparative Embodiment 3 that an excessively large central thickness affects the transmittance. It can be seen from Embodiment 1 and Comparative Embodiment 4 that the transmittance of the multifunctional resin lens for the AR glasses capable of correcting the vision, which is hardened but not plated with a film, is not high. It can be seen from Embodiment 1 and Comparative Embodiment 5 that plating the multifunctional resin lens for the AR glasses capable of correcting the vision with a film may improve the transmittance thereof, but the wear resistance of the lens with no hardened layer does not satisfy the national standard.

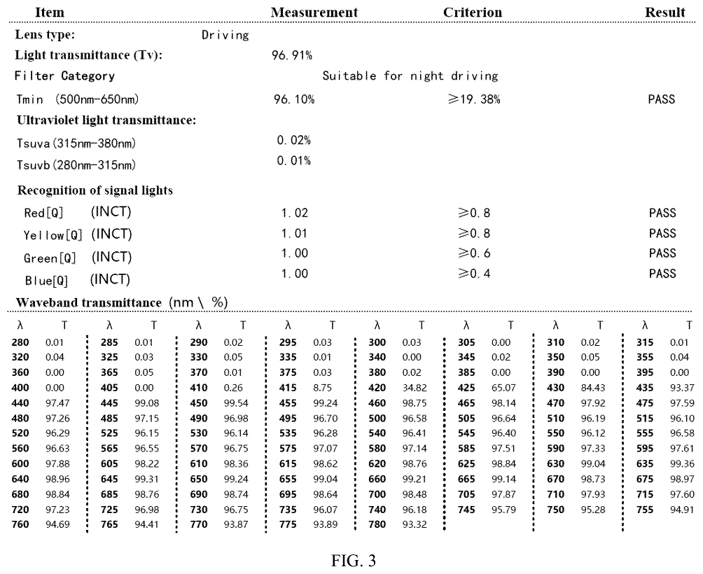

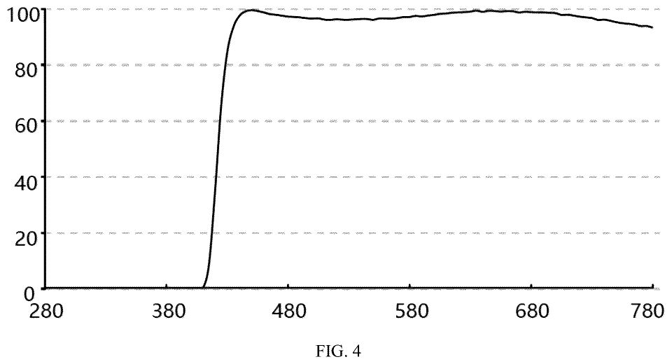

In the present disclosure, FIG. 3 shows the characteristics of a visible light transmittance, and FIG. 4 shows a visible light transmittance diagram of the lens. FIG. 3 shows specific data description of FIG. 4. The visible light transmittance diagram of the lens may be used to represent the transmittance of the lens at different wavelengths. From the visible light transmittance diagram, the light transmittance performance of the lens can be understood more intuitively, and the quality and the imaging effect of the lens can be evaluated.

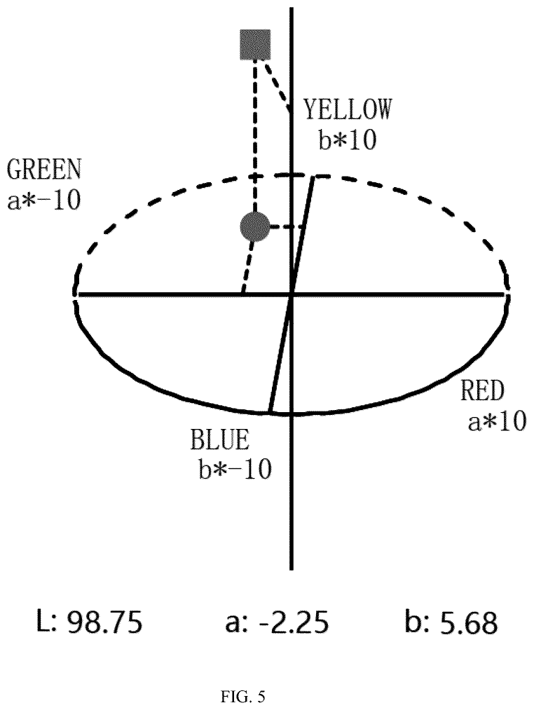

FIG. 5 shows L. a. b values of the visible light transmittance lens for evaluating the quality and the imaging effect of the lens;

The L value represents a light transmittance value;

(1) The L value represents the light transmittance of the lens at a specific angle and a specific wavelength; the higher the L value is, the clearer the lens is, and the better a visual effect is.

(2) The lower the L value is, the obscurer the lens is, and the worse the visual effect is.

The a value is a dispersion coefficient:

(1) The a value represents a refractive index of the lens for the light at different wavelengths; the higher the a value is, the stronger the light refracting power of the lens is.

(2) The higher the refractive index is, the obscurer the imaging at an edge of the lens is, and the more serious the edge distortion is.

The b value represents a coefficient of chromatic aberration;

(1) The b value represents an imaging resolution of the lens in a refraction light path.

(2) The lower the b value is, the clearer the imaging of the lens is.

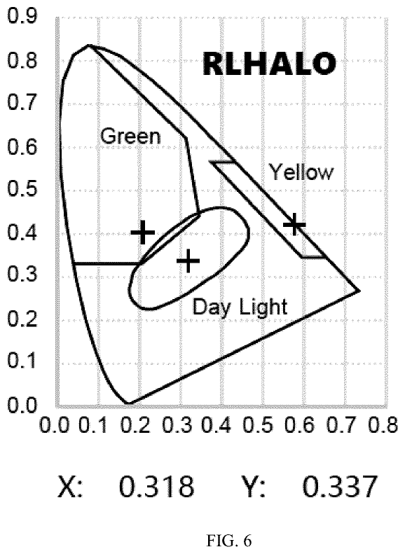

In FIG. 6:

An X value and a Y value are used to describe a variation of the transmittance of the lens in both X and Y directions. The X value represents a projection of a transmittance curve on an X axis, and the Y value represents a projection of the transmittance curve on a Y axis.

It should be noted that, the relational terms such as “first” and “second”, etc. herein are merely used to distinguish one entity or operation from another entity or operation, and do not necessarily require or imply any actual relationship or order between these entities or operations. Moreover, the terms “include”, “comprise”, or any other variations thereof are intended to cover non-exclusive inclusions, such that a process, method, item, or device that includes a series of elements not only includes these elements, but also includes other elements that are not explicitly listed, or also includes elements inherent in such process, method, item, or device.

Although the embodiments of the present disclosure have been illustrated and described, those of ordinary skills in the art may understand that multiple changes, modifications, substitutions, and variations may be made to these embodiments without departing from the principle and spirit of the present disclosure. The scope of the present disclosure is defined by the claims and equivalents thereof.

1. A multifunctional resin lens for AR glasses capable of correcting vision, comprising a lens base (1), wherein multifunctional hard layers (2) are disposed on both upper and lower end faces of the lens base (1); a multifunctional film layer (3) is disposed on the other side of each of the multifunctional hard layers (2); the lens consisting of the lens base (1), the multifunctional hard layers (2), and the multifunctional film layers (3) is a structure having a flat upper end face and a curved lower end face; and an optical waveguide sheet (4) is disposed on the upper multifunctional film layer (3) of the lens base (1).

2. The multifunctional resin lens for the AR glasses capable of correcting the vision of claim 1, wherein the lens base (1) is a multifunctional resin base, the multifunctional resin base comprises any one or more of an anti-blue light base, a color change base, a dyeable base, and an anti-infrared light base, and a material of the lens base (1) includes any one of acrylate, polyurethane, polycarbonate, and allyl carbonate.

3. The multifunctional resin lens for the AR glasses capable of correcting the vision of claim 1, wherein the multifunctional hard layer (2) comprises one or more of an anti-scratch hardened layer, an anti-impact hardened layer, and a dyeable hardened layer.

4. The multifunctional resin lens for the AR glasses capable of correcting the vision of claim 1, wherein the multifunctional film layer (3) comprises any one or more of a light anti-reflection film, an anti-electromagnetic radiation film, a waterproof film, and an anti-fog film.

5. The multifunctional resin lens for the AR glasses capable of correcting the vision of claim 1, wherein the optical waveguide sheet (4) is adhered using an OCA, and an adhesive thickness of the optical waveguide sheet (4) is less than 200 microns.

6. A fabrication method of the multifunctional resin lens for the AR glasses capable of correcting the vision of claim 1, wherein the fabrication method comprises: S1. raw material preparation and molding by casting; S2. demolding pretreatment; S3. multifunctional hard layer dip-coating; S4. lens pre-drying, picking-out, and curing; S5. multifunctional film layer plating; S6. picking-out, packaging, and axis line marking; and S7. optical waveguide sheet adhesion, wherein:
S1. raw material preparation and molding by casting comprises:
a1. preparing and uniformly stirring a multifunctional base raw material; and
a2. injecting the multifunctional base material into two glass molds, one being a flat glass mold and the other being a curved mold, which are sealed using a tape, with a distance between working faces of the two molds being 0.6-3 mm;
S3. multifunctional hard layer dip-coating comprises: dip-coating lenses undergoing S2. demolding pretreatment with multifunctional hard layers for hardening, with a thickness of the multifunctional hard layer being 1.5-5 microns;
S5. multifunctional film layer plating comprises: performing vacuum plating on lenses undergoing S4. lens pre-drying, picking-out, and curing, to plate front and rear surfaces of the lenses with multifunctional film layers respectively.

7. A fabrication method of the multifunctional resin lens for the AR glasses capable of correcting the vision of claim 2, wherein the fabrication method comprises: S1. raw material preparation and molding by casting; S2. demolding pretreatment; S3. multifunctional hard layer dip-coating; S4. lens pre-drying, picking-out, and curing; S5. multifunctional film layer plating; S6. picking-out, packaging, and axis line marking; and S7. optical waveguide sheet adhesion, wherein:
S1. raw material preparation and molding by casting comprises:
a1. preparing and uniformly stirring a multifunctional base raw material; and
a2. injecting the multifunctional base material into two glass molds, one being a flat glass mold and the other being a curved mold, which are sealed using a tape, with a distance between working faces of the two molds being 0.6-3 mm;
S3. multifunctional hard layer dip-coating comprises: dip-coating lenses undergoing S2. demolding pretreatment with multifunctional hard layers for hardening, with a thickness of the multifunctional hard layer being 1.5-5 microns;
S5. multifunctional film layer plating comprises: performing vacuum plating on lenses undergoing S4. lens pre-drying, picking-out, and curing, to plate front and rear surfaces of the lenses with multifunctional film layers respectively.

8. The fabrication method of the multifunctional resin lens for the AR glasses capable of correcting the vision of claim 6, wherein S2. demolding pretreatment in the method comprises:
b1. placing the molds in which the multifunctional base material is injected into a curing oven for curing, at curing temperature of 20-125° C. and for a curing time of 4-48 hours;
b2. taking out cured lenses, tearing off the tape, force-opening the glass molds, and separating the lenses from the glass molds;
b3. edge-grinding the separated lenses into lenses with a specified diameter;
b4. performing ultrasonic cleaning on the ground lenses;
b5. performing secondary curing and annealing treatment on the cleaned lenses, at a temperature of 65-130° C. and for a time of 8-50 hours;
b6. inspecting the lenses undergoing the annealing treatment and picking out qualified lenses;
b7. placing the qualified lenses into a wiping machine for wiping and cleaning;
b8. placing the wiped lenses into an alkaline bath for surface treatment, at an alkaline concentration of 6%-25% and a temperature of 30-60° C.;
b9. placing the lenses undergoing the surface treatment into an ionized water tank for ultrasonic cleaning, at a temperature of 30-60° C.; and
b10. air-drying surfaces of the cleaned lenses.

9. The fabrication method of the multifunctional resin lens for the AR glasses capable of correcting the vision of claim 6, wherein S4. lens pre-drying, picking-out, and curing in the method comprises:
c1. pre-drying the lenses dip-coated with the multifunctional hard layers after S3. multifunctional hard layer dip-coating;
c2. inspecting the pre-dried lenses and picking out qualified lenses; and
c3. curing the hardened qualified lenses.

10. The fabrication method of the multifunctional resin lens for the AR glasses capable of correcting the vision of claim 6, wherein S6. picking-out, packaging, and axis line marking in the method comprises:
d1. inspecting the plated lenses undergoing S5. multifunctional film layer plating, and picking out qualified lenses;
d2. printing and packaging the qualified lenses;
d3. picking out lenses with cylinders, identifying an optical center and an axis line of each of the lenses on a lensometer, and marking a direction of the axis line on a back surface of the lens;
d4. marking the axis line passing through the optical center of the lens on the back surface of the lens using ink; and
d5. processing spherical lenses and line-marked cylindrical lenses into lenses of required shapes and sizes.

11. The fabrication method of the multifunctional resin lens for the AR glasses capable of correcting the vision of claim 6, wherein S7. optical waveguide sheet adhesion in the method comprises: adhering an optical waveguide sheet to an optical center position on a flat front surface of the lens using an OCA.
